(19) United States
(12) Patent Application Publication
(10) Pub. No.: US 2008/0132241 A1
(43) Pub. Date: Jun. 5, 2008

(54) METHOD AND APPARATUS TO FACILITATE USING A PATH TO DYNAMICALLY SCHEDULE WIRELESS ACCESS POINT SUPPORT FOR A GIVEN COMMUNICATION SYSTEM

(75) Inventors: Paul R. Hancock, Barrington, IL (US); Charles D. Gavrilovich, Park Ridge, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/564,950

(22) Filed: Nov. 30, 2006

(51) Int. Cl. H04Q 7/20

(52) U.S. Cl. 455/450

(57) ABSTRACT

A server (502) that is participating in a communication session with a mobile device (400) determines (101) that this mobile device has need for a given amount of bandwidth in service of a given communication session while moving with respect to a plurality of wireless access points to a particular geographic destination. Upon then automatically determining (102) a path by which this mobile device will likely move to that destination this server can then use this path information to dynamically schedule support (103) (by at least some of the plurality of wireless access points) for that communication session while also providing at least the given amount of bandwidth. So configured, this communication session can remain fully and substantially continuously serviced by various ones of the wireless access points with at least the given amount of bandwidth as the mobile device moves to the target geographic destination.

### TECHNICAL FIELD

This invention relates generally to wireless communications and more particularly to mobile wireless communications.

### BACKGROUND

Wireless communications systems of various kinds are known in the art and new approaches are often being developed as well. In many cases a given user interfaces with the system via a wireless access point. The wireless access point, in turn, often couples directly or indirectly to other access points and/or one or more networks to permit one-way or two-way communications between the user and one or more other parties or entities.

Many such systems will accommodate a mobile user. More particularly, many systems will permit an on-going communication session to be switched (or handed-off) without substantial interruption from one access point to another as the mobile user moves in and out of the service areas for such access points. In many cases existing approaches in this regard serve adequately enough. In a growing number of instances, however, existing approaches in this regard present a sub-optimal experience.

As one illustrative example in this regard, a given mobile user may require a particular quantity of bandwidth in a system that supports varying levels of bandwidth support. Support for an ongoing communication session can suffer, then, when a relatively high bandwidth call is necessarily switched from one access point to another when the destination access point does not have sufficient presently available bandwidth. This can present a noticeable and objectionable reduction in delivered quality of service. For example, delivery of an on-going substantially real-time video as comprises a part of a presently on-going communication session can endure a noticeable reduction in the quality of the video content in such an instance.

### BRIEF DESCRIPTION OF THE DRAWINGS

The above needs are at least partially met through provision of the method and apparatus to facilitate using a path to dynamically schedule wireless access point support for a given communication session described in the following detailed description, particularly when studied in conjunction with the drawings, wherein:

FIG. 1 comprises a flow diagram as configured in accordance with various embodiments of the invention;

FIG. 2 comprises a flow diagram as configured in accordance with various embodiments of the invention;

FIG. 3 comprises a flow diagram as configured in accordance with various embodiments of the invention;

FIG. 4 comprises a block diagram as configured in accordance with various embodiments of the invention;

FIG. 5 comprises a block diagram as configured in accordance with various embodiments of the invention; and

FIG. 6 comprises a top plan schematic block diagram as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

Generally speaking, pursuant to these various embodiments, a server that is participating in a communication session with a particular mobile device can determine that this particular mobile device has present and future needs for a given amount of bandwidth in service of a given communication session while moving with respect to a plurality of wireless access points to a particular geographic destination. Upon then automatically determining a path by which this mobile device will likely move to that particular geographic destination this server can then use this path information to dynamically schedule support (by at least some of the plurality of wireless access points) for that given communication session while also providing at least the given amount of bandwidth. So configured, this given communication session can remain fully and substantially continuously serviced by various ones of the plurality of wireless access points with at least the given amount of bandwidth as the particular mobile device moves to the particular geographic destination.

There are various ways by which such a path can be determined. By one approach, the mobile device can simply provide its planned routing information to the server. By another approach, in combination with the above or in lieu thereof, the server can instruct the mobile device as to a particular route to follow or can otherwise basically just predict the path by which the mobile device will likely move to a given geographic destination.

These teachings will also readily accommodate, if desired, detecting when such a mobile device has at least substantially deviated from the aforementioned path and then automatically determining a new path by which the mobile device will now likely move to the geographic destination. The server can then use the new path information to dynamically schedule support as before for the mobile device and that on-going communication session.

So configured, these teachings can greatly ameliorate or even obviate the kinds of quality-of-service degradations that have characterized the prior art in such application settings. Those skilled in the art will recognize and appreciate that these teachings comprise a highly flexible and economical approach that will accommodate use with a wide variety of communication system architectures, protocols, and the like. It will further be appreciated that these teachings are highly scalable and can be well employed with any number of access points, mobile devices, and so forth.

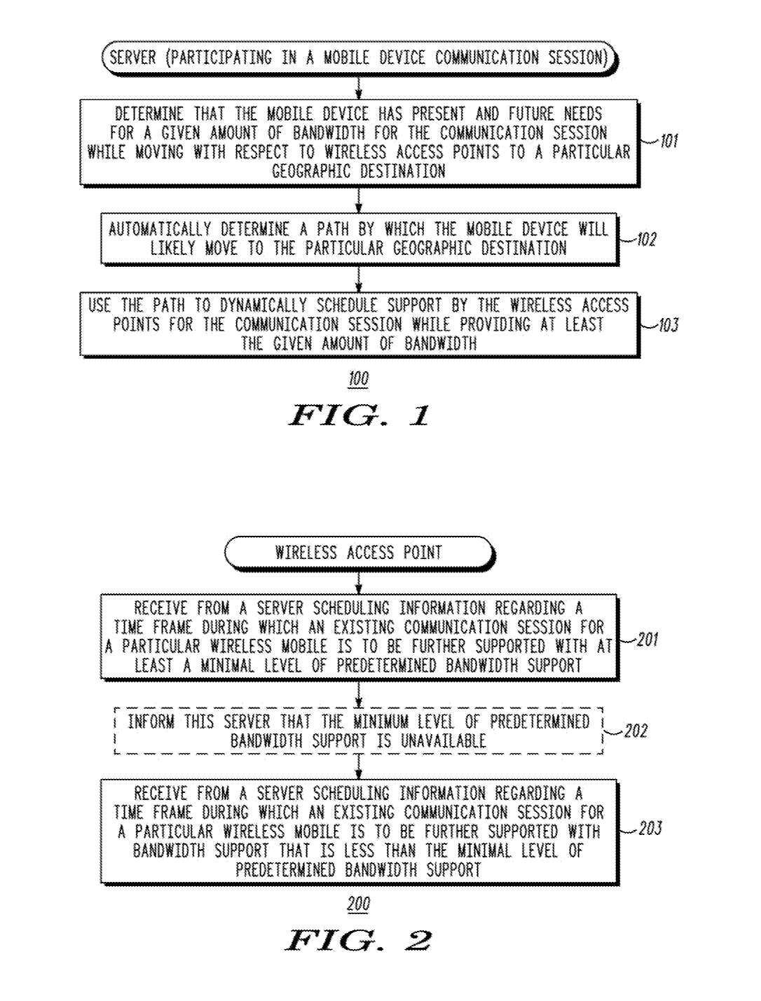

These and other benefits may become clearer upon making a thorough review and study of the following detailed description. Referring now to the drawings, and in particular to FIG. 1, an illustrative process 100 that can be employed by a server, while that server is participating in a communication session with a particular mobile device, provides for determining 101 that this particular mobile device has present and future needs for a given amount of bandwidth in service of a given communication session while moving with respect to a plurality of wireless access points to a particular geographic destination. There are various ways by which such a determination can be accomplished. Depending upon the needs and/or opportunities associated with a given application setting, by one approach, this can comprise, at least in part, receiving a message from the particular mobile device via the communication session with the server regarding, at least in part, the given amount of bandwidth, a present location of the particular mobile device, and the particular geographic destination.

Other information could also be provided via such a message if desired. Such other information could include, if desired, information regarding a scheduled or estimated amount of time that the mobile device will require the indicated amount of bandwidth, a scheduled and/or estimated time of arrival at the particular geographic destination, and so forth.

In the example provided above, the server receives this message from the mobile device. By one approach this can comprise a direct communication as suggested by the example provided. This process 100 will also accommodate, however, receiving such information more indirectly. For example, a media server and/or a presence server may keep the server apprised of such information. By this approach, the services described below as rendered by this server could be offered in a more transparent manner to the mobile device.

It would also be possible for this server to make the described determination upon referring to schedule information as may be available, for example, in an available profile for the mobile device. Such a profile might reveal, for example, that a given user leaves a first location (such as their home) every weekday at approximately 7 AM and travels to a given destination (such as their office) with an intent to arrive by about 8 AM.

This process 100 then provides for having the server automatically determine 102 a path by which the particular mobile device will likely move to the particular geographic destination. This can comprise, for example, receiving the path information from the particular mobile device (as may be available when the mobile device has (or itself comprises) a navigational aid that includes route planning functionality). In such a case, the corresponding route information can be provided to the server along with, or as a supplement to, the previously mentioned message(s).

By another approach, the automatic determination 102 can comprise having the server predict a path by which the particular mobile device will likely move to the particular geographic destination. In this case, the server can make its own prediction or can, if desired, access a route planning resource (such as a route planning server) to receive the predicted path information.

If desired, such a prediction can be based upon more than simply the start and end points of the route. For example, it would also be possible to further inform such route predicting with profile information that may be available regarding the user/mobile device. Such a profile, for example, might reveal that this user has a preference for (or aversion to) Interstate highways when available, unless those highways are toll-bearing, in which case the user prefers alternative routes. As another example, such a profile might indicate that this user greatly prefers routes that avoid the use of left turns. As yet another example, a given user's profile might stipulate that the user prefers a shortest distance route or that the user prefers a route that will offer the shortest travel time. When available, such information can be used to better predict the particular route by which the mobile device will likely traverse the distance to its intended destination.

If desired, when the server itself determines the route by which the mobile device will likely travel, the server can communicate that route information to the mobile device as either a recommended path and/or as a point of confirmation. By informing the mobile device of the recommended path, the mobile device can then move to the particular geographic destination using that recommended path. By this approach, the server can effectively serve as a navigation aid for the mobile device while also potentially increasing the effective accuracy of the prediction regarding the likelihood of the mobile device actually following this particular predicted route.

This process 100 then provides for having the server use the path to dynamically schedule support 103, by at least some of the aforementioned plurality of wireless access points, for the given communication session while providing at least the given amount of bandwidth required by the mobile device for that session. So configured, the given communication session will tend to remain fully and substantially continuously serviced by various ones of the plurality of wireless access points with at least the given amount of bandwidth as the particular mobile device moves to the particular geographic destination.

This can be based, at least in part, upon a priori knowledge regarding the existence, location, and relative service areas of the wireless access points. Such information can be already available (via, for example, look-up tables or other data retention mechanisms) and/or can be dynamically developed by querying and/or probing such wireless access points regarding such characterizing information. Other information of potential benefit might comprise, but is not limited to, information regarding supported frequency bands, modulation types, encryption, protocols, identifiers, and so forth.

As will be shown below, this can comprise scheduling various ones of the wireless access points to provide such support at the mobile device moves in, and out, of their respective service areas. By one approach, this can comprise scheduling such support within a particular window of time (based upon a calculated time by when the mobile device will reach specific locations along the predicted path). For example, a first wireless access point can be scheduled to provide a given level of support from around time T1 to time T2 while a second wireless access point is scheduled to provide that same level of support from around time T2 to time T3, and so forth. Such scheduling helps to avoid unduly over-scheduling a given wireless access point as might occur by simply reserving service at all wireless access points along the path for the entire duration of the journey. This, in turn, permits a higher overall level of genuine usage of wireless access point resources and improves overall bandwidth usage and throughput for all users.

By one approach, such scheduling can occur completely transparently to the mobile device itself. That is, the support of the mobile device may be automatically switched from wireless access point to wireless access point with the mobile device playing a relatively passive role. By another approach, such scheduling can include a more active role for the mobile device. This might include, for example, transmitting scheduling information to the mobile device (such as information regarding scheduled support times, wireless access point information, and so forth) to permit the mobile device to use such information in a more proactive manner during the course of the journey.

Such attempts at scheduling, of course, may reveal that given wireless access points are unable to provide the necessary level of support at the requested times. This might occur because the wireless access point is simply without that level of bandwidth capability as a native capability. This might also occur, for example, because the wireless access point has a scheduling conflict that leaves that wireless access point with diminished capability during at least part of the requested window of support time.

In such a case, if desired, the wireless access point can respond to the server with information regarding this inability to provide the requested support along with information regarding what level of support could be provided at the times requested. Upon determining that this wireless access point is unable to provide the given amount of bandwidth as requested, the server can then take appropriate responsive actions. This could comprise, for example, using an alternative wireless access point (or points) that can provide the necessary level of service along the predicted path as a substitute for the unavailable service of this particular wireless access point. This could also comprise, if desired, scheduling parallel support by two or more such wireless access points in order to provide, in the aggregate, the required amount of bandwidth.

Those skilled in the art will recognize and appreciate that these scheduling actions are taken prior to the immediate need for the corresponding services. This, in turn, provides time to permit such alternatives to be explored when bandwidth deployment options are unavailable as requested without causing an interruption to the real-time flow of data being experienced by the mobile device. As a result, such an approach goes far to facilitate a highly transparent process that preserves the perception and reality of a single continuous uninterrupted experience for the user of the mobile device as they move from their original location to their intended target destination.

It is of course possible that a given mobile device will deviate, and perhaps substantially, from the predicted path. This can occur for any number of reasons including, but not limited to, dynamically changing travel circumstances (reflecting, for example, traffic accidents, unknown obstacles, construction work, and the whims of the driver, to note but a few), an incorrect initial prediction, and so forth. It is also possible for such path deviations to render the aforementioned scheduling unsuitable. The actual path used by the mobile device may be inconsistent with the service scheduling plans such that, unless changed, the mobile device may become without complete (or any) support for the given communication session.

Accordingly, if desired, this step of using the path to dynamically schedule support can itself comprise, upon detecting that the mobile device has at least substantially deviated from the predicted path, automatically determining a new path by which the particular mobile device will likely move to the particular geographic destination. There are various direct and indirect ways by which such a deviation can be detected. By one approach, the server can receive regular (or irregular) updates with respect to the actual location of the mobile device (as may be based, for example, upon global positioning system calculations developed by the mobile device or that are available to the mobile device). There are other known approaches as well by which the location of the mobile device can be ascertained and then communicated to the server for these purposes. As these teachings are not overly sensitive to the selection of any particular approach in this regard, for the sake of brevity and the preservation of focus and clarity further elaboration in this regard will not be provided here.

The server can then use the new path to dynamically schedule support for the given communication session while again providing at least the given amount of needed bandwidth. This can again involve interfacing with various ones of the wireless access points to determine their relative temporal and substantive availability and to schedule their particular participatory roles accordingly. In some cases, this may involve rescheduling in some manner an already-scheduled wireless access point. In other cases it may involve scheduling new wireless access points and/or completely unscheduling previously scheduled wireless access points.

Such rescheduling can occur as often as desired. In some cases the frequency by which the server considers or effects such rescheduling can comprise a fixed operating parameter (as when, for example, such a consideration arises every 30 seconds, every one minute, or the like). By another approach, the regularity by which the server makes this consideration can vary with respect, for example, to the application setting. As one illustration in this regard, when a relatively large number of wireless access points having broadly overlapping relatively large service areas are available, it may not be necessary to make such a determination on any particularly frequent basis.

Referring now to FIG. 2, the aforementioned wireless access points can, in turn, utilize a process 200 whereby the wireless access point receives 201 from the aforementioned server scheduling information regarding a time frame (such as, but not necessarily limited to, an approximate or exact start time at which an existing communication session will likely be handed off to the wireless access point and an approximate or exact end time by when the existing communication session will likely be handed off to yet another wireless access point or otherwise concluded) during which an existing communication session for a particular wireless mobile platform is to be further supported by the wireless access point with at least a minimal level of predetermined bandwidth support. As described above, such information can be used by the recipient wireless access point to schedule the use of its communication resources. As also noted above, this step can comprise the receipt of an initial scheduling activity or can comprise receiving updated scheduling information from the server as the particular wireless mobile platform moves.

As noted above, a given wireless access point may not have sufficient capacity at the indicated times to provide the requested service. In such a case, if desired, the wireless access point can optionally inform 202 the server that the minimal level of predetermined bandwidth support is unavailable. By one approach, this can further comprise providing information regarding an amount of service capacity that the wireless access point could provide during the time period in question. Accordingly, and again if desired, this process 200 can also then optionally provide for receiving 203 from the server scheduling information regarding a time frame during which an existing communication session for a particular wireless mobile platform is to be further supported by the wireless access point with bandwidth support that is less than the minimal level of predetermined bandwidth support (as when this particular wireless access point is scheduled to provide partial support for the given communication session in parallel with one or more other wireless access points that are similarly scheduled and tasked by the server).

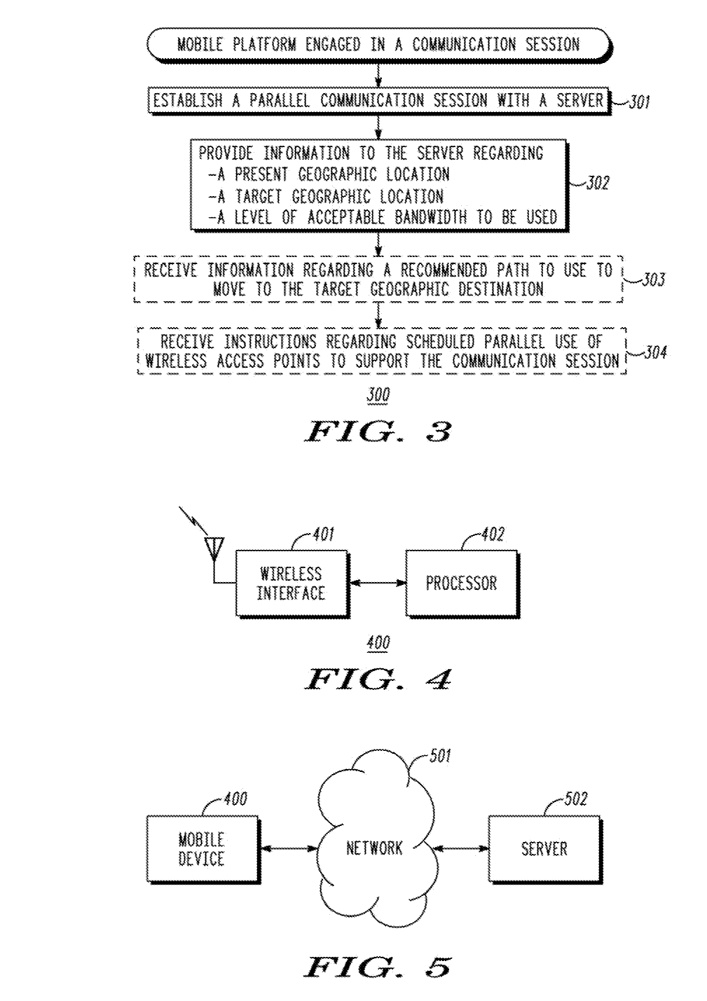

Referring now to FIG. 3, a corresponding illustrative process 300 for the aforementioned mobile platform that is engaged in the ongoing present communication session can provide for establishing 301 a parallel communication session with the aforementioned server in order to facilitate providing 302 information to the server regarding, at least in part, the present geographic location of the wireless mobile platform, a target geographic destination, and a level of acceptable bandwidth to be used when continuing to support the ongoing present communication session as the wireless mobile platform moves to the target geographic destination.

As noted above, this information can further comprise, if desired, information regarding the route that the wireless mobile platform will likely, or intends, to use when moving to the target geographic destination. Also as noted above, this step of providing information to the server can further comprise both the initial provision of such information as well as location updates as the wireless mobile platform moves to the target geographic destination.

As described above, by one approach the server may provide a recommended path to the wireless mobile platform. To accommodate such an approach, if desired, this process 300 can optionally provide for receiving 303, via the aforementioned parallel communication session, information from the server regarding this recommend path by which the wireless mobile platform can move to the target geographic destination. This process 300 can also accommodate receiving information from the server regarding the scheduled use of a variety of wireless access points during the course of the journey to the target geographic destination. This can include, where desired and appropriate, receiving instructions 304 regarding scheduled parallel use of a plurality of wireless access points to support the communication session in a manner that provides the level of acceptable bandwidth (when, for example, two or more wireless access points are providing, in the aggregate, the required level of bandwidth services at a particular point in time).

Those skilled in the art will appreciate that the above-described processes are readily enabled using any of a wide variety of available and/or readily configured platforms, including partially or wholly programmable platforms as are known in the art or dedicated purpose platforms as may be desired for some applications. Referring now to FIG. 4, an illustrative approach to a mobile device will now be provided.

In this illustrative example, a mobile device 400 can comprise a wireless interface 401 (by which the mobile device 400 can engage in the described communication sessions) that operably couples to a processor 402. The processor can comprise a partially or fully programmable platform as are known in the art that is configured and arranged (via, for example, corresponding programming) to establish the aforementioned parallel communication session with a server via the wireless interface 401 and to provide the described information to the server via that parallel communication session regarding the mobile device's 400 present location, a target geographic destination, and the desired or required level of acceptable bandwidth to be used when continuing to support a present on-going communication session as the mobile device 400 moves to the target geographic destination.

This processor 402 can be further configured and arranged to accomplish, as desired, any of the other above described actions and responses as regards to, for example, providing location updates during the course of the journey, receiving recommended paths from the server, and/or receiving instructions regarding the scheduled use of multiple wireless access points in parallel with one another to attain the given level of desired/required quality of service.

Those skilled in the art will recognize and understand that such an apparatus 400 may be comprised of a plurality of physically distinct elements as is suggested by the illustration shown in FIG. 4. It is also possible, however, to view this illustration as comprising a logical view, in which case one or more of these elements can be enabled and realized via a shared platform. It will also be understood that such a shared platform may comprise a wholly or at least partially programmable platform as are known in the art.

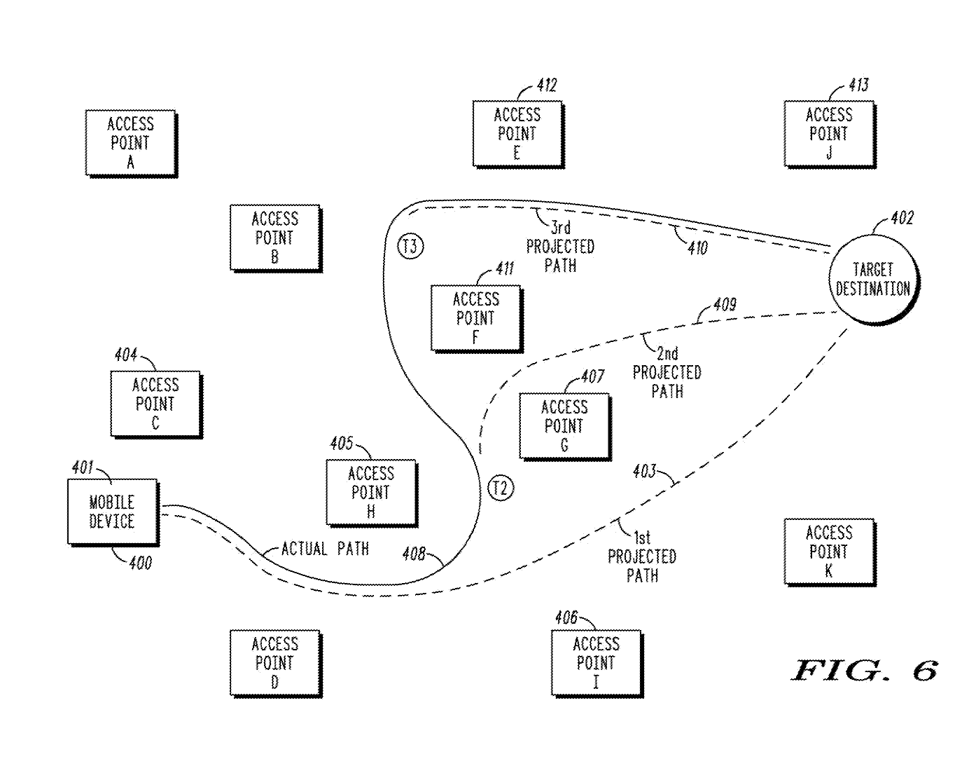

With reference to FIG. 5, those skilled in the art will recognize and understand that the mobile device 400 can interface via one or more intervening networks 501 with the described server 502. Such a network(s) 501 may be fully or only partially wireless and can include both private and public intranets and extranets (such as the Internet) as appropriate to the needs and opportunities as pertain to a given application setting. Numerous architectural and protocol options exist in this regard and the present teachings are not particularly sensitive to any particular selections in this regard. Accordingly, for the sake of brevity additional detail will not be provided here.

To illustrate these teachings, an example will provided described with reference to FIG. 6. Those skilled in the art will recognize and understand that this description serves an illustrative purpose only and does not represent, nor is it intended to represent, an exhaustive listing of all possibilities in this regard.

The aforementioned mobile device 400 has an initial location 401. The mobile device 400 reports this initial location 402 along with information regarding a target destination 402 and the needed bandwidth requirements to the aforementioned server (not shown in this depiction for the sake of clarity). The server then determines a first projected path 403 that is deemed likely to be used by the mobile device 400. The server uses this first projected path 403 to then schedule wireless access point resources to provide the desired level of support to the mobile device 400 as the latter moves to the target destination 402. In this illustrative example, this might comprise scheduling, at time T1 and in chronological order, wireless access point C 404, wireless access point H 405, wireless access point I 406, and wireless access point G 407 during particular corresponding windows of time as described above.

Later, at time T2, the server determines (as per the above teachings) that the mobile device 400 is pursuing an actual path 408 that has deviated substantially from the first projected path 403. In response, and again as per these teachings, the server re-determines a new, second projected path 409 by which the mobile device 400 is deemed likely to move to the target destination 402. In view of this change, the server now alters the scheduling to drop use of wireless access point I 406 and to now switch earlier to access point G 407.

Now still later, at time T3, the server again determines that the mobile device 400 has again pursued an actual path 408 that has substantially deviated from the second projected path 409. In response, the server now determines a new, third projected path 410 to the target destination 402 and uses that third projected path 410 to de-schedule wireless access point G 407 and to schedule instead, for chronological use in consecutive windows of time, wireless access point F 411 in combination with wireless access point E 412 (where neither of these wireless access points 411 and 412 are independently able to provide the required quality of service but can, together in parallel and in the aggregate, provide a satisfactory quantity of bandwidth) and wireless access point J 413.

In this illustrative example, the actual path 408 of the mobile device 400 now substantially tracks with the third projected path 410 and no further modifications to the schedule are required.

It would of course be possible to modify the scheduling of such wireless access points to respond to temporal changes that are not otherwise related to deviations from the projected path. For example, such location reports can be used to confirm that the mobile device remains on track with a projected path but is either ahead of or behind their projected progress. This, in turn, may be used to modify the scheduling of the wireless access points to account for such temporal deviations from the previous scheduling plan.

These teachings are highly flexible and can be used in combination with a wide range of communications systems and approaches. These teachings can even be readily applied in conjunction with a system-agile mobile device that is capable of operating compatibly with a number of different systems (and hence different kinds of wireless access points). Those skilled in the art will recognize and appreciate as well that these teachings are readily scalable and can be employed with a relatively few or large number of wireless access points, mobile devices, servers, and so forth. So configured, these teachings provide for a significant degree of assurance that a given on-going communication session will not be unduly interrupted due to movement of the mobile device through a variety of service areas as correspond to a multitude of wireless access points.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

We claim:

1. A method comprising:
at a server and while participating in a communication session with a particular mobile device:
determining that the particular mobile device has present and future needs for a given amount of bandwidth in service of a given communication session while moving with respect to a plurality of wireless access points to a particular geographic destination;
automatically determining a path by which the particular mobile device will likely move to the particular geographic destination;
using the path to dynamically schedule support, by at least some of the plurality of wireless access points, for the given communication session while providing at least the given amount of bandwidth such that the given communication session remains fully and substantially continuously serviced by various ones of the plurality of wireless access points with at least the given amount of bandwidth as the particular mobile device moves to the particular geographic destination.

2. The method of claim 1 wherein determining that the particular mobile device has present and future needs for a given amount of bandwidth in service of a given communication session while moving with respect to a plurality of wireless access points to a particular geographic destination comprises, at least in part, receiving a message from the particular mobile device via the communication session regarding, at least in part, the given amount of bandwidth, a present location of the particular mobile device, and the particular geographic destination.

3. The method of claim 1 wherein automatically determining a path by which the particular mobile device will likely move to the particular geographic destination comprises predicting a path by which the particular mobile device will likely move to the particular geographic destination.

4. The method of claim 1 wherein automatically determining a path by which the particular mobile device will likely move to the particular geographic destination comprises:
determining a recommended path by which the particular mobile device can move to the particular geographic destination;
informing the particular mobile device of the recommended path such that the particular mobile device can move to the particular geographic destination using the recommended path.

5. The method of claim 1 wherein using the path to dynamically schedule support, by at least some of the plurality of wireless access points, for the given communication session while providing at least the given amount of bandwidth further comprises:
detecting that the particular mobile device has at least substantially deviated from the path;
automatically determining a new path by which the particular mobile device will likely move to the particular geographic destination;
using the new path to dynamically schedule support, by at least some of the plurality of wireless access points, for the given communication session while providing at least the given amount of bandwidth such that the given communication session remains fully and substantially continuously serviced by various ones of the plurality of wireless access points with at least the given amount of bandwidth as the particular mobile device moves to the particular geographic destination.

6. The method of claim 1 wherein using the path to dynamically schedule support, by at least some of the plurality of wireless access points, for the given communication session while providing at least the given amount of bandwidth further comprises:
determining that a given one of the plurality of wireless access points is unable to provide the given amount of bandwidth;
scheduling parallel support by at least two of the plurality of wireless access points in order to provide the given amount of bandwidth.

7. A method comprising:
in a wireless mobile platform engaged in a communication session;
establishing a parallel communication session with a server;
providing information to the server via the parallel communication session regarding, at least in part:
a present geographic location of the wireless mobile platform;
a target geographic destination;
a level of acceptable bandwidth to be used when continuing to support the communication session as the wireless mobile platform moves to the target geographic destination.

8. The method of claim 7 wherein providing information to the server via the parallel communication session further comprises providing location updates to the server as the wireless mobile platform moves to the target geographic destination.

9. The method of claim 7 further comprising:
receiving from the server, via the parallel communication session, information regarding a recommended path by which the wireless mobile platform can move to the target geographic destination.

10. The method of claim 7 further comprising:
receiving instructions regarding scheduled parallel use of a plurality of wireless access points to support the communication session in a manner that provides the level of acceptable bandwidth.

11. A wireless mobile platform comprising:
a wireless interface by which the wireless mobile platform engages in a communication session;
a processor operably coupled to the wireless interface and that is configured and arranged to:
establish a parallel communication session with a server via the wireless interface;
providing information to the server via the parallel communication session regarding, at least in part:
a present geographic location of the wireless mobile platform;
a target geographic destination;
a level of acceptable bandwidth to be used when continuing to support the communication session as the wireless mobile platform moves to the target geographic destination.

12. The wireless mobile platform of claim 11 wherein the processor is further configured and arranged to provide location updates to the server as the wireless mobile platform moves to the target geographic destination.

13. The wireless mobile platform of claim 11 wherein the wireless interface further serves to receive from the server, via the parallel communication session, information regarding a recommended path by which the wireless mobile platform can move to the target geographic destination.

14. The wireless mobile platform of claim 11 wherein the wireless interface further serves to receive instructions regarding scheduled parallel use of a plurality of wireless access points to support the communication session in a manner that provides the level of acceptable bandwidth.

15. A method comprising:
at a wireless access point:
receiving from a server scheduling information regarding a time frame during which an existing communication session for a particular wireless mobile platform is to be further supported by the wireless access point with at least a minimal level of predetermined bandwidth support.

16. The method of claim wherein the scheduling information comprises, at least in part:
an approximate start time at which the existing communication session will likely be handed off to the wireless access point;
an approximate end time by when the existing communication session will likely be handed off to yet another wireless access point.

17. The method of claim 16 wherein receiving from a server scheduling information regarding a time frame during which an existing communication session for a particular wireless mobile platform is to be further supported by the wireless access point further comprises receiving updated scheduling information from the server as the particular wireless mobile platform moves.

18. The method of claim 15 further comprising:
informing the server that the minimal level of predetermined bandwidth support is unavailable.

19. The method of claim 18 further comprising:
receiving from the server scheduling information regarding a time frame during which an existing communication session for a particular wireless mobile platform is to be further supported by the wireless access point with bandwidth support that is less than the minimal level of predetermined bandwidth support.
